(19) United States
(12) Patent Application Publication
(10) Pub. No.: US 2008/0145091 A1
(43) Pub. Date: Jun. 19, 2008

(54) IMAGE FORMING APPARATUS AND POWER COUPLING DEVICE THEREOF

(75) Inventor: In Hak HWANG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/876,814

(22) Filed: Oct. 23, 2007

(30) Foreign Application Priority Data
Dec. 14, 2006 (KR) 2006-127904

(51) Int. Cl. G03G 15/00

(52) U.S. Cl. 399/88

(57) ABSTRACT

An image forming apparatus includes an improved structure to prevent a user from coupling expendable supplies in incorrect positions upon replacement, and a power coupling device is mounted in the image forming apparatus as the improved structure. The power coupling device includes a plurality of driving couplers provided at a drive unit, and a plurality of driven couplers provided at a driven structure to correspond to the driving couplers, respectively. Each of the driving couplers has a first coupling portion to be coupled with a corresponding one of the driven couplers, and each of the driven couplers has a second coupling portion having a configuration corresponding to that of the first coupling portion. At least two of the first coupling portions have different cross sections from each other. The driven structure, adapted to receive power of the drive unit, includes a toner cartridge, photosensitive member, etc. provided in a developing unit of the image forming apparatus.

### CROSS-REFERENCE TO RELATED APPLICATIONS

This application claims the benefit of Korean Patent Application No. 2005-0127904, filed on Dec. 14, 2006 in the Korean Intellectual Property Office, the disclosure of which is incorporated herein by reference.

### BACKGROUND OF THE INVENTION

1. Field of the Invention

The present general inventive concept relates to an image forming apparatus, and more particularly, to an image forming apparatus having a power coupling device to transmit power of a drive unit to driven elements.

2. Description of the Related Art

An image forming apparatus is designed to print an image on a sheet of paper as a printing medium according to an image signal inputted thereto. In an electro-photographic image forming apparatus, light is scanned onto a photosensitive member that is electrically charged with a predetermined electric potential, so as to form an electrostatic latent image on an outer peripheral surface of the photosensitive member. Then, after a toner as a developing agent is supplied onto the electrostatic latent image to develop the electrostatic latent image into a visual image, the visual image is transferred and fixed onto a sheet of paper, thereby being printed on the sheet of paper.

The image forming apparatus generally includes a process cartridge in which the photosensitive member, an electrical-charge unit, a developing unit, etc., are integrated to construct a single structure. The process cartridge is detachably connected to a drive unit within the image forming apparatus by means of a power coupling device.

The process cartridge generally receives a predetermined amount of toner equal to certain number of average sheets of printed paper, but internal constituent elements of the process cartridge have a longer lifespan than that of the predetermined amount of toner. Accordingly, it is uneconomical to replace the process cartridge after the toner is completely used. For this reason, there has recently been developed an image forming apparatus in which a toner cartridge for storing a toner is separately provided such that the toner cartridge can be replaced economically after the toner is completely used.

In the above described cases that main elements required for development of the image, including a toner reservoir and the photosensitive member, are integrated in the single process cartridge, and that the main elements are provided separately from the toner cartridge for easy replacement of toner, the process cartridge or toner cartridge is connected to the drive unit via the power coupling device.

Generally, a color image forming apparatus uses a plurality of process cartridges or toner cartridges of four colors including yellow, magenta, cyan, and black colors. When the plurality of discriminate cartridges are used and any one of the cartridges is completely used, it is necessary for a user to select a correct cartridge having the same color as that of the used cartridge and install the selected cartridge in a predetermined position of the image forming apparatus. However, the power coupling device included in the conventional image forming apparatus has no structure for preventing incorrect coupling of the cartridge, and therefore, there is the problem that the user may install the cartridge in an incorrect position by mistake.

### SUMMARY OF THE INVENTION

The present general inventive concept provides an image forming apparatus having an improved structure to prevent a user from coupling expendable supplies, such as toner cartridges, in incorrect positions of the image forming apparatus upon replacement of the toner cartridges, and a power coupling device for use in the image forming apparatus.

Additional aspects and utilities of the present general inventive concept will be set forth in part in the description which follows and, in part, will be obvious from the description, or may be learned by practice of the general inventive concept.

The foregoing and/other aspects and utilities of the present general inventive concept may be achieved by providing an image forming apparatus including first and second developers, a first driving coupler to transmit power from a driving unit to the first developer, a first driven coupler provided at the first developer and coupled to the first driving coupler, a second driving coupler to transmit power from the driving unit to the second developer, and a second driven coupler provided at the second developer and coupled to the second driving coupler, wherein the first and second driving couplers or the first and second driven couplers have different cross-sectional shapes.

The cross-sectional shapes of the first and second driving couplers may include polygonal cross sections.

The cross-sectional shapes of the first and second driving couplers ma include regular polygonal cross sections.

The cross-sectional shapes of the first and second driving couplers may include cross sections inscribed in circles having different diameters from each other.

The foregoing and/other aspects and utilities of the present general inventive concept may be achieved by providing an image forming apparatus comprising a plurality of developers each to feed a toner onto an electrostatic latent image formed on a photosensitive member, and a power coupling device to transmit power of a drive unit, which is provided in a body of the image forming apparatus, to the plurality of developers, wherein the power coupling device includes a plurality of driving couplers provided at the drive unit per each developer, and a plurality of driven couplers provided at the plurality of developers, respectively, to correspond to the respective driving couplers, wherein each of the driving couplers has a first coupling portion to be coupled with a corresponding one of the driven couplers, and each of the driven couplers has a second coupling portion having a configuration corresponding to a configuration of the first coupling portion, and wherein at least two of the first coupling portions have different cross sections from each other.

The first coupling portions may have polygonal cross sections, and preferably, have regular polygonal cross sections.

Any two of the first coupling portions may have cross sections inscribed in circles having different diameters from each other.

The plurality of driving couplers may include four first coupling portions provided per color, and the four first coupling portions may have a regular triangular cross section, a square cross section, a regular pentagonal cross section, and a regular hexagonal cross section, respectively.

The foregoing and/other aspects and utilities of the present general inventive concept may also be achieved by providing an image forming apparatus comprising a plurality of developers to feed toners provided per color onto an electrostatic latent image formed on a photosensitive member, a plurality of toner cartridges to feed the toners provided per color into the plurality of developers, and a power coupling device to transmit power of a drive unit, which is provided in a body of the image forming apparatus, to the plurality of toner cartridges, wherein the power coupling device includes a plurality of driving couplers provided at the drive unit per each color, and a plurality of driven couplers provided at the plurality of toner cartridges, respectively, to correspond to the respective driving couplers, wherein each of the driving couplers has a first coupling portion to be coupled with a corresponding one of the driven couplers, and each of the driven couplers has a second coupling portion having a configuration corresponding to a configuration of the first coupling portion, and wherein at least two of the first coupling portions have different cross sections from each other.

Each of the plurality of toner cartridges may comprise: a toner storage container; a rotating shaft rotatably mounted to the toner storage container, the rotating shaft being coupled to a corresponding one of the driven couplers, and an agitating member mounted to the rotating shaft and adapted to agitate the toner stored in the toner storage container while being rotated together with the rotating shaft.

The foregoing and/other aspects and utilities of the present general inventive concept may also be achieved by providing an image forming apparatus comprising a plurality of photosensitive members provided per color of toners, and a power coupling device to transmit power of a drive unit, which is provided in a body of the image forming apparatus, to the plurality of photosensitive members, wherein the power coupling device includes a plurality of driving couplers provided at the drive unit per each color, and a plurality of driven couplers provided at the plurality of photosensitive members, respectively, to correspond to the respective driving couplers, wherein each of the driving couplers has a first coupling portion to be coupled with a corresponding one of the driven couplers, and each of the driven couplers has a second coupling portion having a configuration corresponding to a configuration of the first coupling portion, and wherein at least two of the first coupling portions have different cross sections from each other.

The foregoing and/other aspects and utilities of the present general inventive concept may also be achieved by providing a power coupling device of an image forming apparatus, which is used to transmit power of a drive unit to a driven structure, wherein the power coupling device comprises a plurality of driving couplers provided at the drive unit, and a plurality of driven couplers provided at the driven structure, so as to correspond to the driving couplers, respectively, wherein each of the driving couplers has a first coupling portion to be coupled with a corresponding one of the driven couplers, and each of the driven couplers has a second coupling portion having a configuration corresponding to a configuration of the first coupling portion, and wherein at least two of the first coupling portions have different cross sections from each other.

The first coupling portions may have polygonal cross sections, and preferably, have regular polygonal cross sections.

Any two of the first coupling portions may have cross sections inscribed in circles having different diameters from each other.

The driven structure may comprise rotating shafts rotatably mounted, respectively, to four toner cartridges per color. Also, the driven structure may comprise four photosensitive members per color that are provided in the image forming apparatus.

The plurality of driving couplers may include four first coupling portions per color, and the four first coupling portions may have a regular triangular cross section, a square cross section, a regular pentagonal cross section, and a regular hexagonal cross section, respectively.

The regular triangular, square, and regular pentagonal cross sections of the first coupling portions may be inscribed in a circle having a first radius, and the regular hexagonal cross section of the first coupling portion may be inscribed in a circle having a second radius smaller than the first radius.

The first coupling portions and the second coupling portions may be protrusions and recesses. In this case, the first coupling portions have an axially twisted structure.

The foregoing and/other aspects and utilities of the present general inventive concept may also be achieved by providing an image forming apparatus including a photosensitive member, a developing unit to develop an image of the photosensitive member with a toner, and a power coupling device to transmit a power of a drive unit to at least one of the photosensitive member and the developing unit, the power coupling device including a plurality of driving couplers provided at the drive unit, and a plurality of driven couplers provided at the one of the photosensitive member and the developing unit to correspond to the respective driving couplers, wherein each of the driving couplers has a first coupling portion to be coupled with a corresponding one of the driven couplers, and each of the driven couplers has a second coupling portion having a configuration corresponding to a configuration of the first coupling portion, and wherein at least two of the first coupling portions have different cross sections from each other.

The foregoing and/other aspects and utilities of the present general inventive concept may also be achieved by providing an image forming apparatus, including a photosensitive member, a developing unit to develop one or more images of the photosensitive member with one or more developers, and a power coupling device to transmit a power of a drive unit to one of the photosensitive member and the developing unit, the power coupling device including a plurality of driving couplers provided at the drive unit and having different shapes, and a plurality of driven couplers provided at the one of the photosensitive member and the developing unit, and having different shapes of the driving couplers to be coupled to corresponding ones of the driving couplers.

The foregoing and/other aspects and utilities of the present general inventive concept may also be achieved by providing an image forming apparatus including a photosensitive member, a developing unit to develop one or more images of the photosensitive member with one or more developers, and a power coupling device to transmit a power of a drive unit to one of the photosensitive member and the developing unit, the power coupling device including first and second driving couplers provided at the drive unit and having a first shape and a second shape, respectively, and first and second driven couplers provided at the one of the photosensitive member and the developing unit, and having a third shape and a fourth shape to exclusively match the first shape and the second shape when the first and second driving couplers are coupled to the first and second driven couples, respectively.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a diagrammatic view illustrating an image forming apparatus according to an embodiment of the present invention;

FIG. 2 is a perspective view illustrating the image forming apparatus of FIG. 1;

FIG. 3 is a diagrammatic view illustrating a drive unit and a power coupling device included in the image forming apparatus of FIG. 1;

FIG. 4 is a perspective view illustrating a toner cartridge and a power coupling device included in the image forming apparatus of FIG. 1;

FIGS. 5A to 5D are perspective view illustrating the power coupling device of FIG. 4;

FIG. 6 is a diagrammatic view illustrating a relationship of different cross sections of first coupling portions of the power coupling device of FIGS. 1-5D;

FIG. 7 is a perspective view illustrating first and second coupling portions of a power coupling device of an image forming apparatus according to an embodiment of the present general inventive concept; and

FIG. 8 is a perspective view illustrating a drive unit, photosensitive members, and a power coupling device according to an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

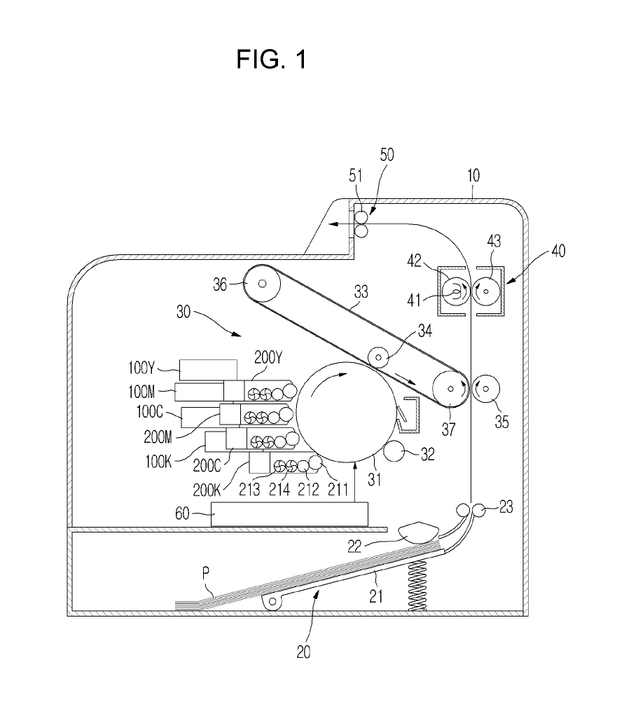

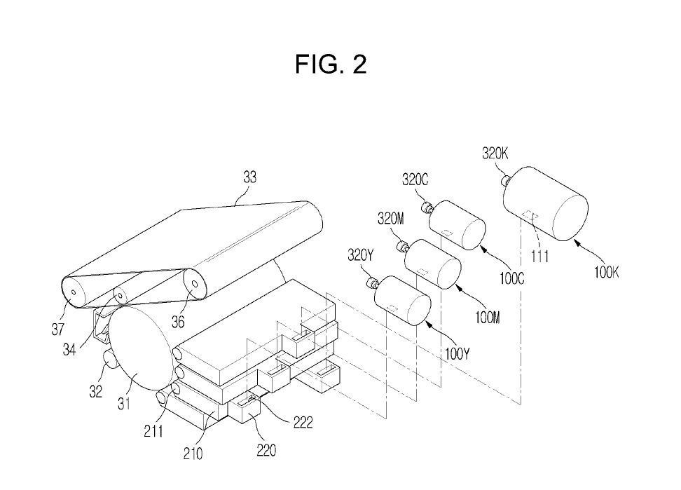

FIG. 1 is a diagrammatic view illustrating an image forming apparatus according to an embodiment of the present general inventive concept. FIG. 2 is a perspective view illustrating the image forming apparatus of FIG. 1.

As illustrated in FIG. 1, the image forming apparatus includes a body 10 to define an outer appearance of the image forming apparatus and to support a variety of elements installed therein, a paper feeding unit 20 to feed one or more sheets of paper P as a printing medium, a developing unit 30 to develop an image on each sheet of paper, a fixing unit 40 to fix the developed image on the sheet of paper by applying a predetermined pressure and heat to the sheet of paper, and a paper discharge unit 50 to discharge the printed sheet of paper out of the body 10.

The paper feeding unit 20 includes a paper feeding tray 21 in which sheets of paper P are loaded, a pickup roller 22 to pick up the sheets of paper P loaded in the paper feeding tray 21 one by one, and transport rollers 23 to move the picked-up sheets of paper toward the developing unit 30.

The developing unit 30 includes a photosensitive member 31 having a surface on which an electrostatic latent image is formed by a light-exposure unit 60, an electrical-charge roller 32 to electrically charge the photosensitive member 31, four toner cartridges 100K, 100C, 100M, and 100Y to store Black, Cyan, Magenta, and Yellow toners, respectively, four developers 200K, 200C, 200M, and 200Y adapted, respectively, to develop the electrostatic latent image formed on the photosensitive member 31 into a toner image upon receiving the toner from the corresponding toner cartridge 100K, 100C, 100M, or 100Y, an intermediate transfer belt 33, and first and second transfer rollers 34 and 35. Hereinafter, when it is necessary to distinguish elements depending on their colors, reference letters K, C, M and Y are added to reference numerals denoting the respective elements.

The intermediate transfer belt 33 is supported by supporting rollers 36 and 37 such that it travels at the same speed as a rotating speed of the photosensitive member 31. The first transfer roller 34 is arranged to face the photosensitive member 31 through the intermediate transfer belt 33 and adapted to transfer the toner image developed on the photosensitive member 31 onto the intermediate transfer belt 33. The second transfer roller 35 is arranged to face the intermediate transfer belt 33. The second transfer roller 35 is spaced apart from the intermediate transfer belt 33 while the toner image is transferred from the photosensitive member 31 onto the intermediate transfer belt 33, but comes into contact with the intermediate transfer belt 33 with a predetermined pressure if the toner image is completely transferred onto the intermediate transfer belt 33.

The fixing unit 40 serves to fix the toner image on the sheet of paper by applying a predetermined pressure and heat onto the sheet of paper. The fixing unit 40 includes a heating roller 42 having a heat source 41 to apply heat to the sheet of paper having the transferred toner image, and a press roller 43 installed opposite to the heating roller 42 to keep a predetermined fixing pressure between the heating roller 42 and the press roller 43.

The paper discharge unit 50 includes a series of paper discharge rollers 51 arranged in sequence to transport the sheets of paper, having passed through the fixing unit 40, to the outside of the body 10.

As illustrated in FIGS. 1 and 2, each of the developers 200K, 200C, 200M, and 200Y includes a body 210 having a developing roller 211 and a toner reservoir 220 having an opening 222 to receive the toner from a corresponding one of the toner cartridges 100K, 100C, 100M, and 100Y. The toner reservoir 220 also has a conveyance unit (not shown) to transport the toner from the corresponding toner cartridge 100K, 100C, 100M, or 100Y into the body 210. The conveyance unit may be selected from among an auger, a conveyance belt, etc. In addition to the developing roller 211, the body 210 has a feeding roller 212 and first and second augers 213 and 214. The first and second augers 213 and 214 serve to convey the toner fed through the toner reservoir 220 toward the feeding roller 212. The feeding roller 212 serves to attach the toner to the developing roller 211 while being rotated in contact with the developing roller

Each of the toner cartridge 100K, 100C, 100M, and 100Y includes a shutter (not shown) to close a toner feeding hole 111 when the toner cartridge is separated from the image forming apparatus, and to open the toner feeding hole 111 when the toner cartridge is mounted to the image forming apparatus. With the above described configuration, if the toner stored in any one of the toner cartridges 100K, 100C, 100M, and 100Y is completely used, only the used toner cartridge can simply be replaced.

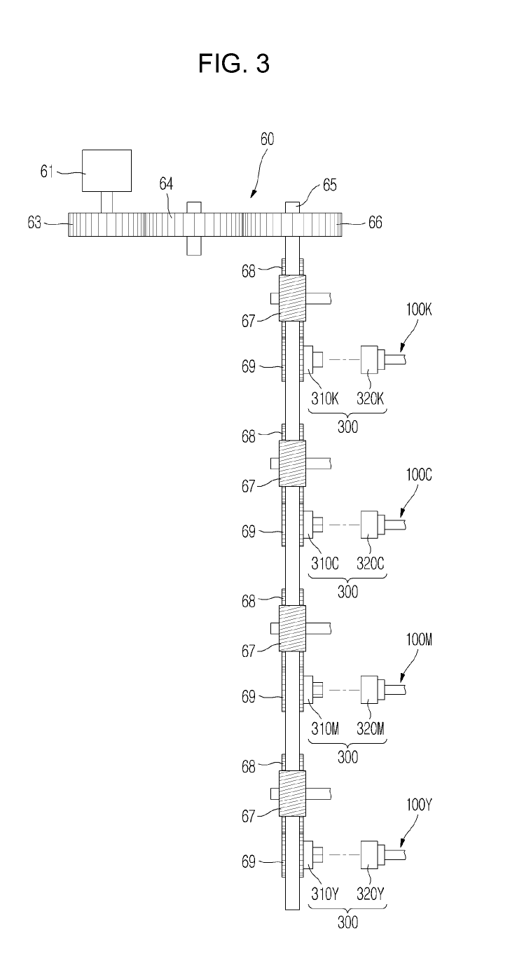

FIG. 3 is a diagrammatic view showing a drive unit 60 and a power coupling device 30 included in the image forming apparatus of FIG. 1.

As illustrated in FIG. 3, the image forming apparatus further includes the drive unit 60 disposed in the body 10 to provide driving power to elements mounted in the toner cartridges 100K, 100C, 100M, and 100Y, and the power coupling device 300 to transmit the power of the drive unit 60 to driven elements mounted in the toner cartridges 100K, 100C, 100M, and 100Y.

The drive unit 60 includes a drive motor 61, and a power transmission mechanism to transmit power of the drive motor 61 toward the toner cartridges 100K, 100C, 100M, and 100Y. The drive motor 61 may be used to operate only the driven elements mounted in the toner cartridges 100K, 100C, 100M, and 100Y. Alternatively, in addition to the elements mounted in the toner cartridges 100K, 100C, 100M, and 100Y, the drive motor 61 may be used to operate elements mounted in the developers 200K, 200C, 200M, and 200Y and other elements of the image forming apparatus including the photosensitive member 31.

The power transmission mechanism includes a first power transmission gear 64 to engage a pinion 63 connected to the drive motor 61, a second power transmission gear 66 provided at one end of a power transmission shaft 65 and configured to engage the first transmission gear 64, a plurality of worm gears 67 arranged on the power transmission shaft 65 with a predetermined interval, worm wheels 68 engaged with the worm gears 67, and driving gears 69 to rotatably engage the worm wheels 68.

The driving gears 69 are provided with driving couplers 310K, 310C, 310M, and 310Y of the power coupling device 300, respectively. When the toner cartridges 100K, 100C, 100M, and 100Y are mounted in the image forming apparatus, the driving couplers 310K, 310C, 310M, and 310Y are coupled with driven couplers 320K, 320C, 320M, and 320Y provided at the toner cartridges 100K, 100C, 100M, and 100Y. When the toner cartridges 100K, 100C, 100M, and 100Y are separated from the image forming apparatus, the driving couplers 310K, 310C, 310M, and 310Y are separated from the driven couplers 320K, 320C, 320M, and 320Y. Detailed configuration of the power coupling device 300 will be described hereinafter.

Although not shown in the drawings, to relieve a shock caused upon installation of the toner cartridges 100K, 100C, 100M, and 100Y, or to ensure strong coupling between the driving couplers 310K, 310C, 310M, and 310Y and the driven couplers 320K, 320C, 320M, and 320Y, elastic members may be installed between the driving gears 69 and the driving couplers 310K, 310C, 310M, and 310Y, or one surface of the respective driving gears 69 opposite to the driving couplers 310K, 310C, 310M, and 310Y.

The above described drive unit according to the present embodiment is exemplary, and may be appropriately changed as needed by design so long as it can provide power required to operate the driven elements mounted in the toner cartridges 100K, 100C, 100M, and 100Y.

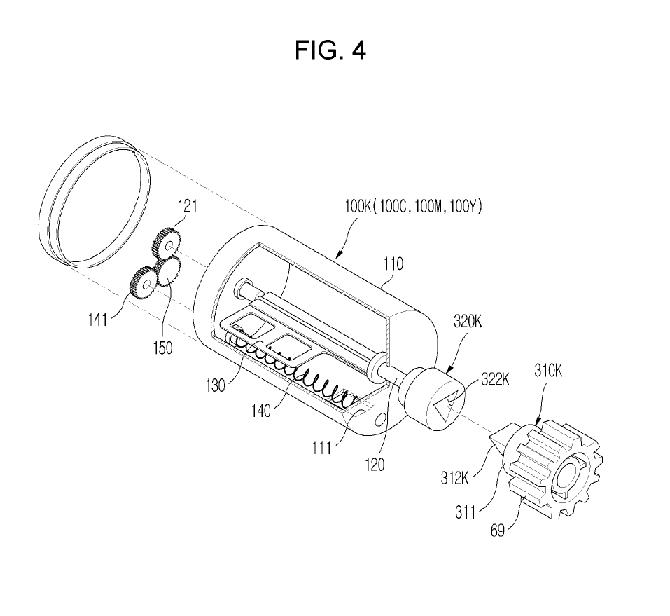

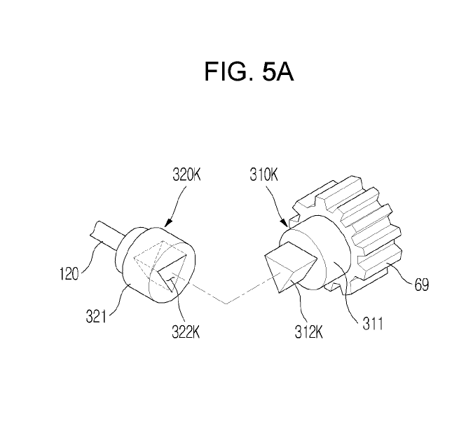

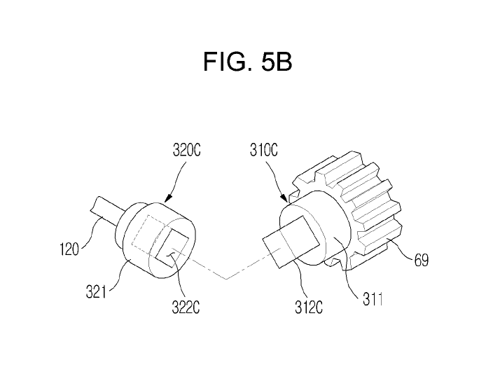

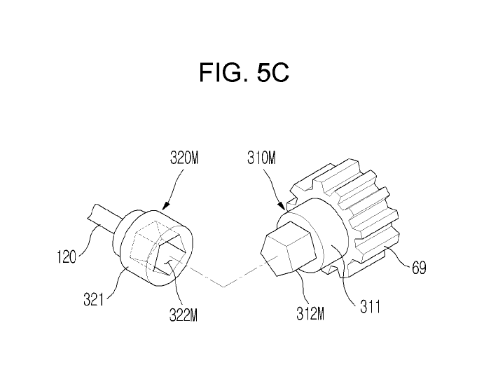

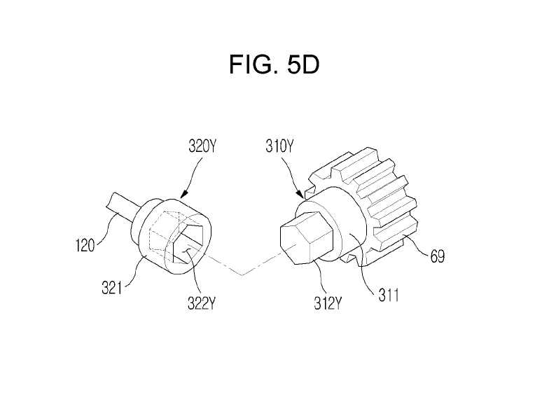

FIG. 4 is a perspective view illustrating the toner cartridge 100K, 100C, 100M, or 100Y and the power coupling device 300 of the image forming apparatus of FIGS. 1 and 3. FIGS. 5A to 5D are perspective view illustrating the power coupling device 300 of FIG. 4. Specifically, FIG. 4 illustrates any one of the toner cartridges 100K, 100C, 100M, and 100Y, for example, the black toner cartridge 100K, and the corresponding power coupling device. FIGS. 5A to 5D illustrate the power coupling device 300 with respect to black, cyan, magenta, and yellow colors according to an exemplary embodiment of the present general inventive concept.

As illustrated in FIG. 4, each of the toner cartridges 100K, 100C, 100M, and 100Y includes a toner storage container 110 to store the corresponding color of toner therein, a rotating shaft 120 rotatably mounted to the toner storage container 110, and an agitating member 130 mounted to the rotating shaft 120 and adapted to agitate the toner stored in the toner storage container 110 while being rotated together with the rotating shaft 120.

The toner storage container 110 has the toner feeding hole 111 to discharge the toner agitated by the agitating member 130 into an opening 222 of the corresponding body 100. A conveyance coil 140 is mounted in the toner storage container 110 and adapted to convey the toner toward the toner feeding hole 111. A gear 141 is coupled to one end of the conveyance coil 140 such that a rotating force of the rotating shaft 120 is transmitted to the conveyance coil 140.

One end of the rotating shaft 120 is coupled to the driven coupler 320K that is coupled with the driving coupler 310K on the driving gear 69, so as to receive the power of the drive unit 60. The other end of the rotating shaft 120 is coupled with a gear 121. A connecting gear 150 is interposed between the gear 141 and the gear 121 to transmit power. Accordingly, a rotating force of the driving gear 69 is transmitted to the rotating shaft 120 via the driving coupler 310K and the driven coupler 320K, and then, a rotating force of the rotating shaft 120 is transmitted to the conveyance coil 140 via the gears 121, 150, and 141.

As shown in FIGS. 4 and 5A to 5D, each of the driving couplers 310K, 310C, 310M, and 310Y has a first base portion 311 protruded from one surface of the driving gear 69, and a first coupling portion 312K, 312C, 312M, or 312Y provided on the first base portion 311 and configured to be coupled with a corresponding one of the driven couplers 320K, 320C, 320M, and 320Y. Each of the driven couplers 320K, 320C, 320M, and 320Y has a second base portion 321 coupled to the end of the rotating shaft 120, and a second coupling portion 322K, 322C, 322M, or 322Y formed in the second base portion 321, the second coupling portion 322K, 322C, 322M, or 322Y having a shape corresponding to that of the first coupling portion 312K, 312C, 312M, or 312Y, so as to be coupled with the first coupling portion 312K, 312C, 312M, or 312Y. Although it is illustrated in FIGS. 5A to 5D that the first coupling portions 312K, 312C, 312M, and 312Y take the form of protrusions, and the second coupling portions 322K, 322C, 322M, and 322Y take the form of corresponding recesses, it will be appreciated that, conversely, the first coupling portions may take the form of recesses and the second coupling portions may take the form of protrusions.

In the present embodiment, the first coupling portions 312K, 312C, 312M, and 312Y may have different cross sections from one another, to prevent a user from installing the different toner cartridges in incorrect positions. In the embodiment shown in FIGS. 5A to 5D, the first and second coupling portions 312K and 322K, 312C and 322C, 312M and 322M, and 312Y and 322Y have a triangular, square, pentagonal, and hexagonal cross section, respectively. However, it will be appreciated that the shown embodiment is exemplary and the cross sections of the first coupling portions 312K, 312C, 312M, and 312Y and the second coupling portions 322K, 322C, 322M, and 322Y may be appropriately changed as needed by design.

The first coupling portions 312K, 312C, 312M, and 312Y may have regular polygonal cross sections. Specifically, in the present embodiment, the first coupling portion 312K may have a regular triangular cross section, the first coupling portion 312C may have a square cross section, the first coupling portion 312M may have a regular pentagonal cross section, and the first coupling portion 312Y may have a regular hexagonal cross section. By providing the first coupling portions 312K, 312C, 312M, and 312Y with the regular polygonal cross sections, it is possible to simplify the design for coinciding rotating centers of the driving and driven couplers with each other. Moreover, the regular polygonal cross sections allows the user to more easily couple the first and second coupling portions with each other upon installation of the toner cartridges.

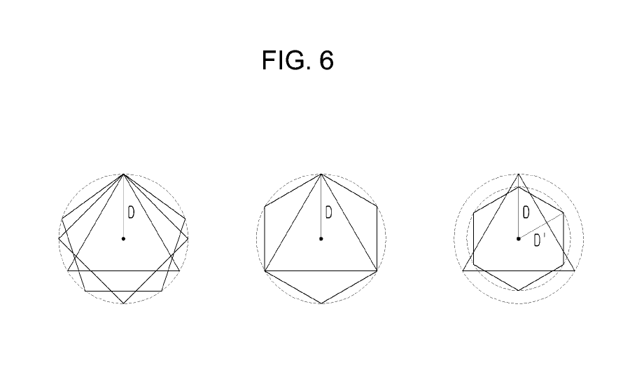

FIG. 6 is a diagrammatic view illustrating a relationship of different cross sections of the first coupling portions of the power coupling device 300 of FIGS. 1-5D. Specifically, as illustrated in the left side of FIG. 6, the cross sections of the first coupling portions 312K, 312C, and 312M with respect to black, cyan, and magenta colors, namely, the triangle, square, and pentagon are inscribed in a circle having a radius D. Also, as illustrated in the center of FIG. 6, the cross sections of the first coupling portions 312K and 312Y with respect to black and yellow colors, namely, the triangle and hexagon are inscribed in the circle having the radius D. It can be appreciated from the left side of FIG. 6 that the triangle, square, and pentagon, which are inscribed in the same circle, do not include one another completely. Accordingly, with the above described configuration, it is possible to prevent the user from installing the different toner cartridges in incorrect positions even though the cross sections of the first coupling portions 312K, 312C, and 312M take the form of polygons inscribed in the same circle.

However, it can be appreciated from the center of FIG. 6 that the triangle and the hexagon, inscribed in the circle having the radius D, include one another completely. Therefore, there is the problem that the yellow toner cartridge 100Y having the hexagonal second coupling portion 322Y may be incorrectly coupled with the triangular first coupling portion 312K. To solve this problem, as illustrated in the right side of FIG. 6, the second coupling portion 322Y having a hexagonal cross section be reduced in size such that the hexagonal cross section of the second coupling portion 322Y is inscribed in a circle having a radius D′ which is less than the radius D. This completely eliminates a possibility of incorrectly coupling the yellow toner cartridge 100Y with the first coupling portion 312K, thereby preventing the incorrect installation of the toner cartridge even if the toner cartridge is installed in an incorrect position.

Although the above description explains the possibility of incorrectly coupling the triangular first coupling portion 312K with the hexagonal second coupling portion 322Y, the possibility of incorrect coupling is not limited to the above description. For example, when the second coupling portion 322Y has an octagonal cross section, the first coupling portion 312C having a square cross section may be incorrectly coupled with the second coupling portion 322Y. Similarly, by reducing the size of the second coupling portion 322Y, it is possible to prevent incorrect installation of the toner cartridge.

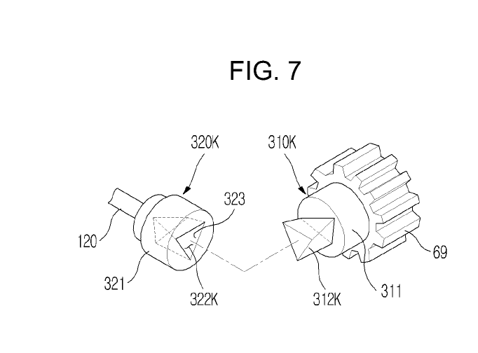

FIG. 7 is a perspective view illustrating a shape of a first coupling portion taking the form of a protrusion in a power coupling device of an image forming apparatus according to an embodiment of the present general inventive concept. Although FIG. 7 illustrates a triangular shape of first and second coupling portions 312K and 322K with respect to the black toner cartridge 100K, the alternative embodiment can be applicable similarly to other first and second coupling portions 312C, 312M, and 312Y and 322C, 322M, and 322Y.

As illustrated in FIG. 7, the first coupling portion 312K takes the form of a protrusion and may be twisted in an axial direction. Accordingly, the second coupling portion 322K takes the form of a recess to correspond to the protrusion and may have an axially extending twist face 323. By providing the first coupling portion 312K and the second coupling portion 322K with the twist structure, it is possible to achieve strong coupling between the first coupling portion 312K and the second coupling portion 322K.

Although the above description explains that the first coupling portions 312K, 312C, 312M, and 312Y have different cross sections from one another, a part of the first coupling portions 312K, 312C, 312M, and 312Y may have the same cross section as each other. In one example, the first coupling portion 312K may have a triangular cross section, and the remaining first coupling portions 312C, 312M, and 312Y may have a square cross section. In another example, the first coupling portion 312K may have a triangular cross section, the first coupling potion 312C may have a square cross section, and the other first coupling portions 312M and 312Y may have a pentagonal cross section.

Hereinafter, the operations of the power coupling device and the image forming apparatus according to the present general inventive concept will be described with reference to FIGS. 1 to 5.

In a state where the photosensitive member 31 is electrically charged with a uniform electric potential by the electrical-charge roller 32, a light beam is irradiated from the light-exposure unit 70 according to information of a yellow image, so as to form an electrostatic latent image, corresponding to the yellow image, on the photosensitive member 31. Then, a development bias is applied to the developing roller 211 of the yellow developer 200Y and a yellow toner is attached to the electrostatic latent image, such that a yellow toner image is developed on the photosensitive member 31. The toner image is transferred onto the intermediate transfer belt 33 by the first transfer roller 34.

If the yellow toner image corresponding to the amount of one page is completely transferred, the light-exposure unit 70 scans a light beam, which corresponds, for example, to information of a magenta image, onto the photosensitive member 31, so as to form an electrostatic latent image corresponding to the magenta image. The magenta developer 200M feeds a magenta toner to the electrostatic latent image, so as to develop the electrostatic latent image. The magenta toner image formed on the photosensitive member 31 is transferred onto the intermediate transfer belt 33 such that the magenta toner image is overlapped with the yellow toner image that was previously transferred onto the intermediate transfer belt 33.

By performing the above described procedure similarly with respect to cyan and black toners, a colored toner image, in which yellow, magenta, cyan, and black toner images are overlapped with one another, can be formed on the intermediate transfer belt 33. The colored toner image is transferred onto a sheet of paper passing between the intermediate transfer belt 33 and the second transfer roller 35. Then, the image transferred onto the sheet of paper can be fixed onto the sheet of paper while the sheet of paper passes through the fixing unit 40.

Meanwhile, the power of the drive unit 60 is transmitted to the respective toner cartridges 100k, 100C, 100M, and 100Y by the power coupling device 300 such that the rotating shaft 120 and the conveyance coil 140 provided in each toner cartridge can be rotated. Thereby, the toners stored in the toner cartridges 100K, 100C, 100M, and 100Y are agitated and fed into the corresponding developers 200K, 200C, 200M, and 200Y. Subsequently, the toners are fed from the developers 200K, 200C, 200M, and 200Y onto the photosensitive member 31 by the developing rollers 211 as described above.

If the toner stored in the toner cartridges 100K, 100C, 100M, or 100Y is completely used during operation of the image forming apparatus, the user has to replace the toner cartridge 100K, 100C, 100M, or 100Y with a new one. In this case, there is a risk in that the user may try to install an incorrect toner cartridge that stores a toner having a different color from that of the used toner in the image forming apparatus by mistake. However, with the present invention, since the coupling portions 312K, 312C, 312M, and 312Y of the driving couplers 310K, 310C, 310M, and 310Y provided at the drive unit 60 have different cross sections from one another, it is possible to prevent an incorrect toner cartridge from being installed in the image forming apparatus even if the user selects the incorrect toner cartridge by mistake. Accordingly, the user can rapidly recognize selection of the incorrect toner cartridge and install a correct toner cartridge in the image forming apparatus.

In the above described embodiment, the elements included in the toner cartridges are driven elements to be operated by the drive unit under operation of the power coupling device. However, the power coupling device of the present invention is not limited to the above described embodiment.

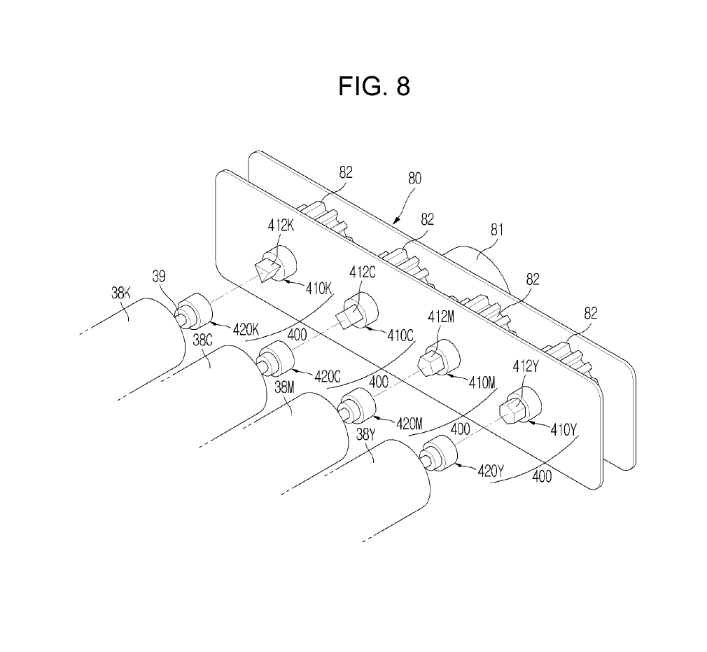

FIG. 8 is a perspective view illustrating a drive unit, photosensitive members, and a power coupling device according to a second embodiment of the present general inventive concept. In the image forming apparatus illustrated in FIG. 8, a drive unit 80 disposed in the body (not shown) is connected to photosensitive members 38K, 38C, 38M, and 38Y provided per a color using a power coupling device 400. Specifically, the present embodiment of FIG. 8 differs from the previously described embodiment in view of the fact that the photosensitive members are driven elements.

The drive unit 80 includes a drive motor 81, and a power transmission mechanism to transmit power of the drive motor 81 to the photosensitive members 38K, 38C, 38M, and 38Y. The power transmission mechanism includes power transmission gears 82 to transmit the power of the drive motor 81 to respective driving couplers 410K, 410C, 410M, and 410Y. Driven couplers 420K, 420C, 420M, and 420Y are provided at one end of the respective photosensitive members 38K, 38C, 38M, and 38Y such that the driven couplers 420K, 420C, 420M, and 420Y are coupled with the driving couplers 410K, 410C, 410M, and 410Y, respectively.

Each of the driving couplers 410K, 410C, 410M, and 410Y has a first coupling portion 412K, 412C, 412M, or 412Y having a polygonal cross section. Although not shown, it will be expected from FIGS. 5A to 5D that each of the driven couplers 420K, 420C, 420M, and 420Y has a second coupling portion having the same cross section as that of the corresponding first coupling portion 412K, 412C, 412M, or 412Y.

In the present embodiment, detailed configurations of the driving and driven couplers are identical to those of the first embodiment of the present invention, and thus, not described repeatedly.

As apparent from the above description, the present general inventive concept has the effect of preventing the user from installing expendable supplies, such as toner cartridges, in incorrect positions of the image forming apparatus upon replacement of the toner cartridges. As a result, it is possible to improve the reliability of products and the convenience of use, and to prevent an image from being contaminated by an unwanted color due to installation of any incorrect toner cartridge.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image forming apparatus comprising:
first and second developers;
a first driving coupler to transmit power from a driving unit to the first developer;
a first driven coupler provided at the first developer and coupled to the first driving coupler;
a second driving coupler to transmit power from the driving unit to the second developer; and
a second driven coupler provided at the second developer and coupled to the second driving coupler,
wherein the first and second driving couplers or the first and second driven couplers have different cross-sectional shapes.

2. The image forming apparatus of claim 1, wherein the cross-sectional shapes of the first and second driving couplers comprise polygonal cross sections.

3. The image forming apparatus of claim 1, wherein the cross-sectional shapes of the first and second driving couplers comprise regular polygonal cross sections.

4. The image forming apparatus of claim 3, wherein the cross-sectional shapes of the first and second driving couplers comprise cross sections inscribed in circles having different diameters from each other.

5. An image forming apparatus comprising:
a photosensitive member;
a plurality of developers each to feed a toner of color onto an electrostatic latent image formed on the photosensitive member;
a plurality of toner cartridges to supply each toner to corresponding ones of the plurality of developers; and
a power coupling device to transmit power of a drive unit to the plurality of toner cartridges,
wherein the power coupling device includes a plurality of driving couplers provided at the drive unit, and a plurality of driven couplers provided at corresponding ones of the plurality of toner cartridges, respectively, to correspond to the respective driving couplers,
wherein each of the driving couplers has a first coupling portion to be coupled with a corresponding one of the driven couplers, and each of the driven couplers has a second coupling portion having a configuration corresponding to a configuration of the first coupling portion, and
wherein at least two of the first coupling portions have different cross sections from each other.

6. The image forming apparatus of claim 5, wherein the first coupling portions have regular polygonal cross sections.

7. The image forming apparatus of claim 6, wherein any two of the first coupling portions have cross sections inscribed in circles having different diameters from each other.

8. The image forming apparatus of claim 6, wherein the plurality of driving couplers include four first coupling portions provided per color, and the four first coupling portions have a regular triangular cross section, a square cross section, a regular pentagonal cross section, and a regular hexagonal cross section, respectively.

9. The image forming apparatus of claim 5, wherein each of the plurality of toner cartridges comprises:
a toner storage container;
a rotating shaft rotatably mounted to the toner storage container, the rotating shaft being coupled to a corresponding one of the driven couplers; and
an agitating member mounted to the rotating shaft and adapted to agitate the toner stored in the toner storage container while being rotated together with the rotating shaft.

10. A power coupling device of an image forming apparatus, which is used to transmit power of a drive unit to a driven structure, comprising:
a plurality of driving couplers provided at the drive unit; and
a plurality of driven couplers provided at the driven structure, so as to correspond to the respective driving couplers,
wherein each of the driving couplers has a first coupling portion to be coupled with a corresponding one of the driven couplers, and each of the driven couplers has a second coupling portion having a configuration corresponding to a configuration of the first coupling portion, and
wherein at least two of the first coupling portions have different cross sections from each other.

11. The power coupling device of claim 10, wherein the first coupling portions each have a polygonal cross section.

12. The power coupling device of claim 10, wherein the first coupling portions each have a regular polygonal cross section.

13. The power coupling device of claim 12, wherein any two of the first coupling portions have a cross section inscribed in circles having different diameters from each other.

14. The power coupling device of claim 10, wherein the driven structure comprises rotating shafts rotatably mounted, respectively, to four toner cartridges per color.

15. The power coupling device of claim 10, wherein the driven structure comprises four photosensitive members per color that are provided in the image forming apparatus.

16. The power coupling device of claim 15, wherein the plurality of driving couplers include four first coupling portions per color, and the four first coupling portions have a regular triangular cross section, a square cross section, a regular pentagonal cross section, and a regular hexagonal cross section, respectively.

17. The power coupling device of claim 16, wherein the regular triangular, square, and regular pentagonal cross sections of the first coupling portions are inscribed in a circle having a first radius, and the regular hexagonal cross section of the first coupling portion is inscribed in a circle having a second radius smaller than the first radius.

18. The power coupling device of claim 10, wherein the first coupling portions comprise a protrusion, and the second coupling portions comprise a recess.

19. The power coupling device of claim 10, wherein the first coupling portions comprise a recess, and the second coupling portions comprise a protrusion.

20. The power coupling device of claim 10, wherein the first coupling portions have a twisted structure in an axial direction thereof.

21. An image forming apparatus, comprising:
a photosensitive member;
a developing unit to develop an image of the photosensitive member with a toner; and
a power coupling device to transmit a power of a drive unit to at least one of the photosensitive member and the developing unit, the power coupling device including:
a plurality of driving couplers provided at the drive unit, and
a plurality of driven couplers provided at the one of the photosensitive member and the developing unit to correspond to the respective driving couplers,
wherein each of the driving couplers has a first coupling portion to be coupled with a corresponding one of the driven couplers, and each of the driven couplers has a second coupling portion having a configuration corresponding to a configuration of the first coupling portion, and
wherein at least two of the first coupling portions have different cross sections from each other.

22. An image forming apparatus, comprising:
a photosensitive member;
a developing unit to develop one or more images of the photosensitive member with one or more developers; and
a power coupling device to transmit a power of a drive unit to one of the photosensitive member and the developing unit, the power coupling device including:
first and second driving couplers provided at the drive unit and having a first shape and a second shape, respectively, and
first and second driven couplers provided at the one of the photosensitive member and the developing unit, and having a third shape and a fourth shape to exclusively match the first shape and the second shape when the first and second driving couplers are coupled to the first and second driven couples, respectively.
